(19) United States
(12) Patent Application Publication
(10) Pub. No.: US 2016/0041561 A1
(43) Pub. Date: Feb. 11, 2016

(54) Aircraft Flying Aid

(71) Applicant: Co-Pilot Engineering, LLC, Springville, UT (US)

(72) Inventors: Donald P. Davies, Springville, UT (US); Steven P. Davies, Ontario, CA (US)

(21) Appl. No.: 14/799,506

(22) Filed: Jul. 14, 2015

Related U.S. Application Data
(60) Provisional application No. 62/035,959, filed on Aug. 11, 2014.

(51) Int. Cl. G05D 1/06; B64D 45/08; B64D 45/04

(52) U.S. Cl. CPC G05D 1/0676; B64D 45/04; B64D 45/08

(57) ABSTRACT

An aircraft flying assist device, system, and method are disclosed. The aircraft flying assist device can include a computation module to receive data from a distance sensor to determine a height above ground between an aircraft and an underlying ground surface, and to determine a vertical velocity of the aircraft. The aircraft flying assist device can also include a command module to determine a flight instruction command to guide a pilot of the aircraft using at least one of the height above ground and the vertical velocity. The flight instruction command can be an aural command deliverable to the pilot via an audio output mechanism.

### RELATED APPLICATIONS

This application claims the benefit of U.S. Provisional Patent Application Ser. No. 62/035,959, filed Aug. 11, 2014, which is incorporated by reference herein in its entirety.

### BACKGROUND

A pilot's performance is often judged by the smoothness of the touchdown during landing of an aircraft. Executing a proper landing flare or round-out is important to a smooth touchdown. In a landing flare, which follows final approach and is prior to touchdown and roll-out, the nose of the aircraft is raised, thus slowing the descent rate and setting the proper aircraft attitude for touchdown.

The landing flare is one of the most difficult flight maneuvers to learn and a challenge to perform well consistently. Some environments, like landing a seaplane on glassy water, can be a challenge for even the most proficient and experienced pilots. To properly execute a landing flare a pilot typically must interpret subtle cues to determine when to initiate the flare and how fast to arrest the descent. Initiating the flare late without proper compensation or arresting the descent too slow results in a hard touchdown or a bounce. Initiating the flare early without proper compensation or arresting the descent too fast results in leveling off too high or floating down the runway. The smoothest touchdowns occur when the pilot can follow an optimum profile in altitude, vertical speed, and angle of attack. While aircraft may have instruments that display altitude, vertical speed, and angle of attack, it can be very difficult for a pilot to rapidly interpret these individual parameters and determine the correct control inputs to apply. At the same time the pilot is performing the landing flare the pilot is also adjusting aileron and rudder inputs as the aircraft speed changes, to compensate for crosswind components to keep the aircraft centered on and aligned with the runway. This in and of itself can demand the pilot's near full attention and often requires the pilot to be continuously monitoring the position and alignment of the aircraft with respect to the runway centerline. This leaves little time for the pilot to monitor instruments for altitude, vertical speed, or angle of attack.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of an aircraft flying assist system in accordance with an example of the present disclosure.

FIG. 2 is a schematic representation of the aircraft flying assist system of FIG. 1.

FIG. 3 is a flowchart illustrating various modes of operation of an aircraft flying assist device or system in accordance an example of the present disclosure.

FIG. 4A is a graphical illustration of a minimum descent rate limit and a maximum descent rate limit in accordance an example of the present disclosure.

FIG. 4B is a plot of an example of an actual landing flare maneuver relative to the minimum descent rate limit and the maximum descent rate limit of FIG. 4A.

FIG. 5 is a flowchart illustrating an initialization operating mode of an aircraft flying assist device or system in accordance an example of the present disclosure.

FIG. 6 is a flowchart illustrating a normal operating mode of an aircraft flying assist device or system in accordance an example of the present disclosure.

FIG. 7 is a flowchart illustrating an armed operating mode of an aircraft flying assist device or system in accordance an example of the present disclosure.

FIG. 8 is a flowchart illustrating a landing flare operating mode of an aircraft flying assist device or system in accordance an example of the present disclosure.

FIG. 9 is a flowchart illustrating various modes of operation of an aircraft flying assist device or system in accordance another example of the present disclosure.

FIG. 10A is an illustration of an angle of attack of a wing of an aircraft in accordance an example of the present disclosure.

FIG. 10B is a graphical illustration of a maximum angle of attack limit and a minimum angle of attack limit in accordance an example of the present disclosure.

FIG. 11 is a flowchart illustrating a normal operating mode of an aircraft flying assist device or system in accordance another example of the present disclosure.

FIG. 12 is a flowchart illustrating a take-off operating mode of an aircraft flying assist device or system in accordance an example of the present disclosure.

FIG. 13 is a flowchart illustrating a final approach operating mode of an aircraft flying assist device or system in accordance an example of the present disclosure.

FIG. 14 is a flowchart illustrating a landing flare operating mode of an aircraft flying assist device or system in accordance another example of the present disclosure.

FIG. 15 is a flowchart illustrating a go-around operating mode of an aircraft flying assist device or system in accordance an example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although some systems exist that provide altitude callouts, such information still requires interpretation by the pilot in order to properly execute a landing flare. Some other systems may provide a display of the altitude. However, a visual display of the altitude requires the pilot to direct visual focus away from the position and alignment of the aircraft with respect to the runway, which can be dangerous. Thus, there is a need for an aircraft flying aid that provides a pilot with guidance, as opposed to mere information, in a manner that does not distract the pilot's visual attention from the task at hand, such as properly aligning the aircraft with respect to the runway.

Accordingly, an aircraft flying assist device, system, and method is disclosed that provides flight instruction commands, such as those that require no interpretation by the pilot. In one aspect, the flight instruction commands can be aural in nature. The audible nature of the flight instruction commands allows the pilot to maintain visual focus and attention on the task of controlling the aircraft. The aircraft flying assist device can include a computation module to receive data from a distance sensor to determine a height above ground between an aircraft and an underlying ground surface, and to determine a vertical velocity of the aircraft. The aircraft flying assist device can also include a command module to determine and issue a flight instruction command to guide a pilot of the aircraft using at least one of the height above ground and the vertical velocity. Although not limited to this, the flight instruction command can be an aural command deliverable to the pilot via an audio output mechanism.

An aircraft flying assist system is also disclosed. The aircraft flying assist system can include a distance sensor. The system can also include a computation module to receive data from the distance sensor to determine a height above ground between an aircraft and an underlying ground surface, and to determine a vertical velocity of the aircraft. In addition, the system can include a command module to determine and issue a flight instruction command to guide a pilot of the aircraft using at least one of the height above ground and the vertical velocity. Again, in one example, the flight instruction command can be an aural command deliverable to the pilot via an audio output mechanism.

Additionally, a method of aiding a pilot in flying an aircraft is disclosed. The method can include determining a height above ground between an aircraft and an underlying ground surface. The method can also include determining a vertical velocity of the aircraft. The method can further include determining a flight instruction command to guide a pilot of the aircraft using at least one of the height above ground and the vertical velocity. In addition, the method can include providing the flight instruction command as an aural or other command deliverable to the pilot, such as via an audio output mechanism. In one aspect, the method can further include determining an angle of attack of a wing of the aircraft, and determining the flight instruction command using the angle of attack, or information pertaining thereto, as an input parameter for determining the flight instruction command.

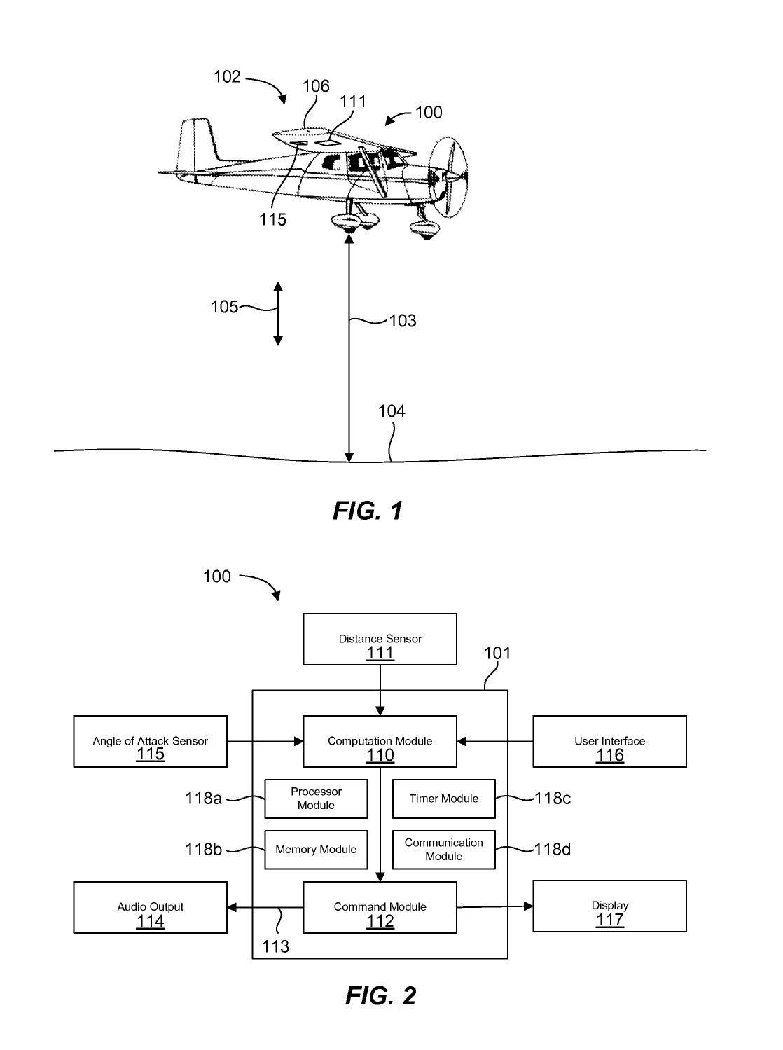

One embodiment of an aircraft flying assist system 100 is illustrated generally in FIG. 1 integrated with or incorporated in an aircraft 102, and illustrated schematically in FIG. 2. With reference to FIGS. 1 and 2, typically, the aircraft 102 will be a general aviation aircraft, although the principles disclosed herein can be applied to, and used with, any suitable type of aircraft. The system 100 can comprise an aircraft flying assist device 101, which can include a computation module 110 to receive data from a distance sensor 111 that can be used to determine a height 103 above ground level

(AGL) between the aircraft 102 and an underlying ground surface 104, which may comprise earth type terrain, water, or a combination of these. In addition, the computation module 110 can determine a vertical velocity 105 of the aircraft 102, such by utilizing the data from the distance sensor 111. The aircraft flying assist device 101 can also include a command module 112 to determine a flight instruction command or callout 113 to guide a pilot of the aircraft 102 using the height 103 above ground and/or the vertical velocity 105. In one aspect, the flight instruction command or callout 113 can comprise an aural command or callout deliverable to the pilot of the aircraft 102 via an audio output mechanism 114. The present system 100 is not limited to providing aural commands. Indeed, those skilled in the art will recognize other methods by which the flight instruction commands or callouts can be communicated to the pilot, such as via one or more visual indicators (e.g., head-up display), haptic or haptical indicators, and others, or any combination of these. In some embodiments, discussed in more detail below, the computation module 110 can be configured to receive data from an angle of attack sensor 115 operative to determine an angle of attack of a wing 106 of the aircraft 102. In this case, the command module 112 can be configured to determine the flight instruction command 113 using the angle of attack, the height 103 above ground, and/or the vertical velocity 105 of the aircraft 102.

Although, as discussed further below, the command module 112 can be configured to provide aural callouts or alerts of a height or altitude, such callouts differ from a flight instruction command in that a flight instruction command is an actionable direction to the pilot as to how to fly the aircraft, such as changing the aircraft's pitch or increasing/decreasing power. Thus, unlike providing a mere callout or alert, the system and device can do some “thinking” for the pilot by interpreting the height above ground, the vertical velocity, the angle of attack, etc. to provide an actionable flight instruction command to the pilot. In addition, unlike an autopilot system where programmed rules govern the control of an aircraft, with the present technology discussed herein the pilot is in control of the aircraft and may make any decision deemed necessary in response to the commands provided by the system. In this case, the decision making of the pilot is advantageously aided or assisted by the aircraft flying assist system 100.

In one aspect, the height information from the distance sensor 111 can be used to provide supplemental information to the pilot in addition to height information from an altitude/elevation above-mean-sea-level (AMSL) altimeter that is typically standard equipment on an aircraft. As described below, the additional information can assist the pilot in various phases of flight, such as landing the aircraft, which can be difficult for a pilot to successfully perform with fluctuating altimeter readings that may result from the standard equipment altimeter in the aircraft. Unlike some visual notification systems, audible callouts and commands provided by the system 100 can enable the pilot to process information while focusing visual attention elsewhere, such as on a runway.

The distance sensor 111 can comprise any suitable distance sensor known in the art, such as a LIDAR (e.g., a laser), a radar, and/or a sonar. In one aspect, the distance sensor can comprise an altimeter, such as a laser altimeter. The distance sensor can be disposed in any suitable location about the aircraft 102, such as on or under the wing 106 or on or under a fuselage. Although the distance sensor 111 can be dedicated only for use with the system 100 and device 101, the distance sensor 111 can be a standard or typical feature of the aircraft 102, such as an existing altimeter (e.g., a laser altimeter) installed on the aircraft 102. The data provided by the distance sensor 111 can therefore be used to calculate or measure the height above ground or the data provided may be a height above ground that has already been calculated or measured.

The angle of attack sensor 115 can comprise any suitable angle of attack sensor known in the art. The angle of attack sensor 115 can be disposed in any suitable location about the aircraft 102, such as on a fuselage. Although the angle of attack sensor 115 can be dedicated only for use with the system 100 and device 101, the angle of attack sensor 115 can be a standard or typical feature of the aircraft 102, such as an existing angle of attack sensor installed on the aircraft 102. The data provided by the angle of attack sensor 115 can therefore be used to calculate or measure the angle of attack or the data provided may be an angle of attack that has already been calculated or measured.

The audio output mechanism 114 can comprise any suitable device or mechanism known in the art for producing sound from an input signal, such as a speaker, a headphone, and/or an electroacoustic transducer. Although the audio output mechanism 114 can be dedicated only for use with the device 101, the audio output mechanism 114 can be a standard or typical feature of the aircraft 102, such as the headset worn by the pilot. Accordingly, the device 101 can output an audio signal (i.e., the flight instruction command 113) as an electrical, digital, and/or optical signal that is compatible, or can be converted to be compatible, with the audio output mechanism 114.

The system 100 can also include a user interface 116 and/or a display 117. The user interface 116 can comprises any suitable user interface known in the art, such as a dial, a knob, a lever, a switch, a button, a keypad, a keyboard, and/or a display (e.g., a touch screen), or a combination of these. Although the user interface 116 and/or the display 117 can be dedicated only for use with the device 101, the user interface 116 and/or the display 117 can be a standard or typical feature of the aircraft 102, such as a digital display and/or a user interface of an avionics system of the aircraft 102.

The device 101 can also include a processor module 118a, a memory module 118b, a timer module 118c and/or a communication module 118d. The processor module 118a, the memory module 118b, and/or the timer module 118c can be operable with the computation module 110 and/or the command module 112 to facilitate determining the height above ground 103, the vertical velocity 105, the angle of attack, and/or the flight instruction command 113, or any combination of these, as well as determining other things. In one aspect, the communication module 118d can include any suitable hardware and/or software to facilitate communication between the various components or modules of the device 101. In another aspect, the communication module 118d can include any suitable hardware (e.g., a transceiver) and/or software to facilitate communication between various components of the system 100 (e.g., the distance sensor 111, the angle of attack sensor 115, the user interface 116, the display 117, and/or the audio output mechanism 114) with the device 101. The communication module 118d can be configured to facilitate wired and/or wireless communication.

In one aspect, the device 101 can be a self-contained or stand-alone unit, which may be retrofitted to an existing aircraft along with any other component of the system 100, such as a distance sensor 111 and/or an angle of attack sensor 115. In this case, the device 101 can be equipped with the user interface 116, the display 117, and/or an audio output mechanism 114. In another aspect, the device 101 can be integrated with or incorporated into an aircraft's existing computer system, such as an avionics system, and utilize an associated processor, memory, hardware, etc. Thus, for example, the device 101 may be implemented at least in part as a computer program executable by an aircraft's computer and utilizing the aircraft's hardware and/or software.

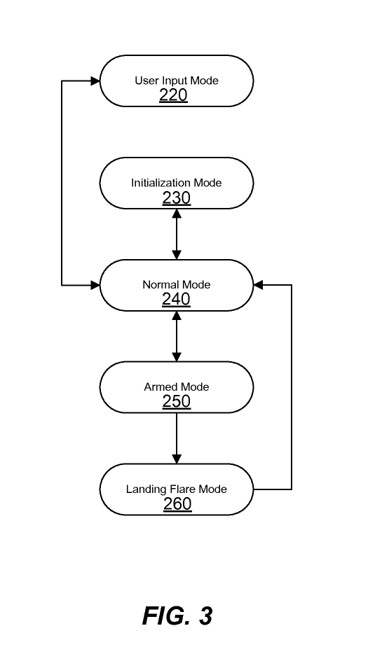

With reference to FIGS. 3-8, various modes of operation of an aircraft flying assist device or system are discussed in accordance with an example of the present disclosure. For example, as illustrated in FIG. 3, an aircraft flying assist device or system can have a user input mode 220, an initialization mode 230, a normal mode 240, an armed mode 250, and a landing flare mode 260. In the user input mode 220, the pilot can set or calibrate various device and system parameters, such as audio and display settings, altitude parameters, landing flare parameters, and angle of attack parameters, as applicable, using a user interface as described herein. The user interface can also be used to switch between different operating modes, such as initiating the user input mode 220 and returning to the normal operating mode 240. In general, the user input mode 220 will be accessed pre-flight when the aircraft is on the ground, but some settings or parameters can be set or adjusted in-flight. For example, a height offset for the distance of the distance sensor from the ground can be set when the aircraft is on the ground to accurately locate the lowest point of the aircraft relative to the ground (i.e., zero AGL altitude when on the ground), while display brightness or audio volume settings can be adjusted at any time to achieve a desirable setting. The user input mode 220 can be accessed from any operating mode at any time, which operating mode can be returned to upon exiting from the user input mode 220.

In one aspect, minimum and maximum flare descent or sink rate limits can be set or adjusted in the user input mode 220. Minimum and maximum flare descent rate limits can be defined by any suitable value or function.

Prior systems, such as those used in commercial aircraft, utilize a linear relationship between height above ground and descent rate for flare control systems. In examples of prior art various ratios between height above ground to change in height above ground per second range on the order of 4:1 to 5:1 and touchdown at about 2.5 feet per second.

Unlike prior systems, the innovations discussed herein provide guidance to a pilot as opposed to a control signal for an autopilot. In some examples, this guidance can be provided in the form of discrete aural commands. In one example, this can be achieved by bracketing the desired rate of descent with minimum and maximum descent rate limits. When the vertical velocity is less than the minimum descent rate limit an aural instruction can be provided to reduce the pitch of the aircraft. As reducing the pitch of the aircraft also reduces the angle of attack of the wing, which reduces the lift produced by the wing, the result is to increase the rate of descent. When the vertical velocity is greater than the maximum descent rate limit an aural instruction can be provided to increase the pitch of the aircraft. As increasing the pitch of the aircraft also increases the angle of attack of the wing, which increases the lift produced by the wing (as long as the critical angle of attack is not exceeded), the result is to reduce the rate of descent. In this way, the pilot is made aware how to correct the descent rate when it deviates beyond some predefined margin from the desired descent rate.

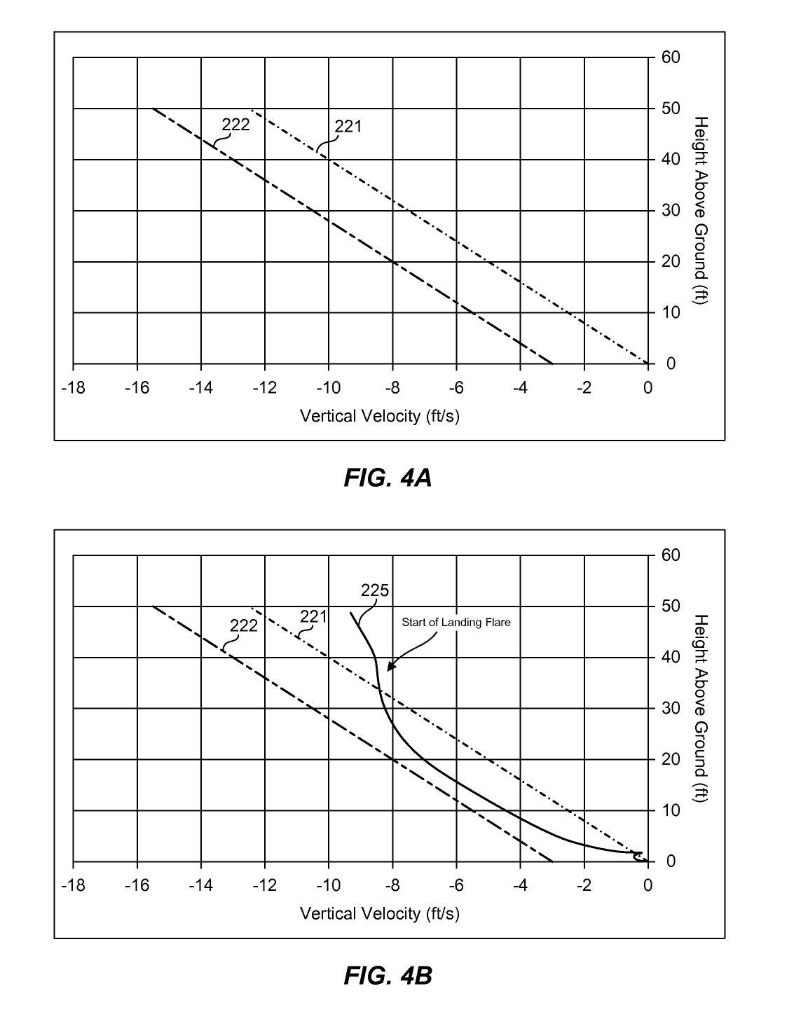

In one test study, an exemplary system incorporating the technology discussed herein was installed on a general aviation aircraft. In one set of flights data was recorded while the pilot performed a series of landings without guidance from the system. The profile of these landings showed one pilot favoring a 4:1 ratio, as depicted in FIGS. 4A and 4B, and another pilot favoring a 3:1 ratio. The latter pilot initiated flares at a lower altitude then flared a little more aggressively. The differences were attributed to pilot preference with both pilots agreeing all of the landings were acceptable. In another set of flights, the pilots were provided aural commands from the system using the limits as depicted in FIGS. 4A and 4B. Both pilots agreed the system was providing valid guidance. One conclusion that can be drawn from the tests is that the success of the landings is not overly sensitive to what ratio is selected for the slope of the limits. That other systems are using a 4:1 ratio on much larger aircraft indicates that ratio is valid for a wide range of aircraft.

Perhaps more sensitive than the slope of the minimum and maximum descent rate limits is what those limits are at a height above ground of zero. For many aircraft, desired touchdown vertical speeds can be between 2 and 3 feet per second, wherein touching down with a vertical speed higher than this is considered a hard landing. Like the ratio for the slope, it is worth noting that the desired touchdown speed seems to vary little across a broad range of aircraft types and operating conditions. An exception is Navy pilots landing on an aircraft carrier where 20 feet per second is an acceptable vertical speed at touchdown. With respect to the present technology, the minimum touchdown vertical speed, as set by the minimum descent rate limit, is zero as it is physically impossible to touchdown (on a level runway) with a descent rate of less than zero. The maximum descent rate limit can be set for a touchdown speed of 3 feet per second. The tests described above showed that this 3 feet per second spread between the minimum and maximum descent rate limits bracketed normal variations from the desired vertical speed during a well-executed flare.

One reason the limits depicted in FIGS. 4A and 4B work well across a wide variety of aircraft types and operating environments is that the height above ground the flare is initiated at is a function of the aircraft sink rate on final approach. An approach with a high sink rate will intersect the limit lines at a high height above ground, whereas an approach with a low sink rate will intersect the limit lines at a low height above ground. The result is the time each aircraft has to arrest the descent is proportional to sink rate that needs to be arrested. This, in turn, results in a uniform rate of vertical deceleration independent of the approach speed or sink rate.

As illustrated in FIG. 4A, an exemplary minimum descent rate limit 221 and/or an exemplary maximum descent rate limit 222 can vary with the height above ground. Although the minimum descent rate limit 221 and/or the maximum descent rate limit 222 shown in the figure vary linearly with the height above ground, the minimum descent rate limit 221 and/or the maximum descent rate limit 222 can vary nonlinearly with the height above ground. When linear, the slope of the minimum descent rate limit 221 and/or the maximum descent rate limit 222 can be initially set to the nominal AGL altitude planned for initiation of the landing flare, divided by the nominal vertical velocity of the aircraft's approach, or the approach sink rate (such as in ft/sec or fps). For example, the landing flare can be planned to begin at 40 feet AGL at a descent rate of 10 fps. The minimum descent rate limit 221 can intersect the origin of the vertical velocity versus height above ground graph as shown in the figure because the vertical velocity cannot be upward when the aircraft contacts the ground upon landing. The maximum descent rate limit 222 can intersect the vertical velocity axis of the graph at the maximum desired vertical velocity when the aircraft contacts the ground upon landing. These locations are not to be limiting. In one aspect, the minimum descent rate limit 221 and the maximum descent rate limit 222 can have the same slope. In this case, the maximum descent rate limit 222 can be offset from the minimum descent rate limit 221 by the maximum desired vertical velocity when the aircraft contacts the ground upon landing. In another aspect, an initial slope of the minimum descent rate limit 221 can be based on a time from initiation of a flare to touchdown. For example, the slope can be derived by taking one half of the time from initiation of a flare to touchdown.

FIG. 4B illustrates a plot 225 of an example of an actual landing flare maneuver relative to the minimum descent rate limit 221 and the maximum descent rate limit 222. In one sense, the flight instruction command or callout 113 can be thought of as a correction factor based on a comparison of an actual height of the aircraft relative to the minimum and maximum flare descent rate limits. The control computer generates the correction factor based on this comparison, which correction factor can comprise a flare correction factor. The flare correction factor can then be communicated to the pilot, such as in an aural command.

It should be understood that the negative values in the graph indicate a negative direction, i.e., toward the ground. Thus, when comparing a vertical velocity to a descent rate limit, “greater than” or “exceeds” means “faster than” and “less than” means “slower than.”

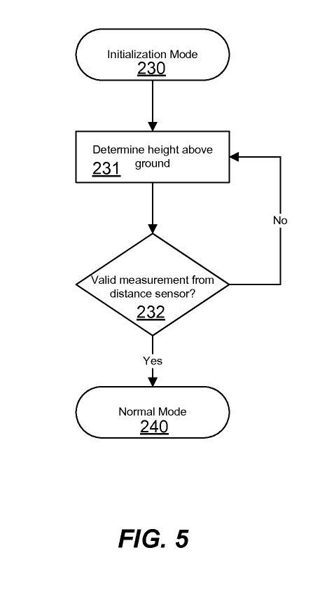

Upon power-up, the system or device can enter the initialization mode 230, as illustrated in FIG. 5. In the initialization mode 230, the height above ground is determined 231. Once a valid measurement is recognized 232 (i.e., zero AGL altitude when on the ground), the normal operating mode 240 can be entered.

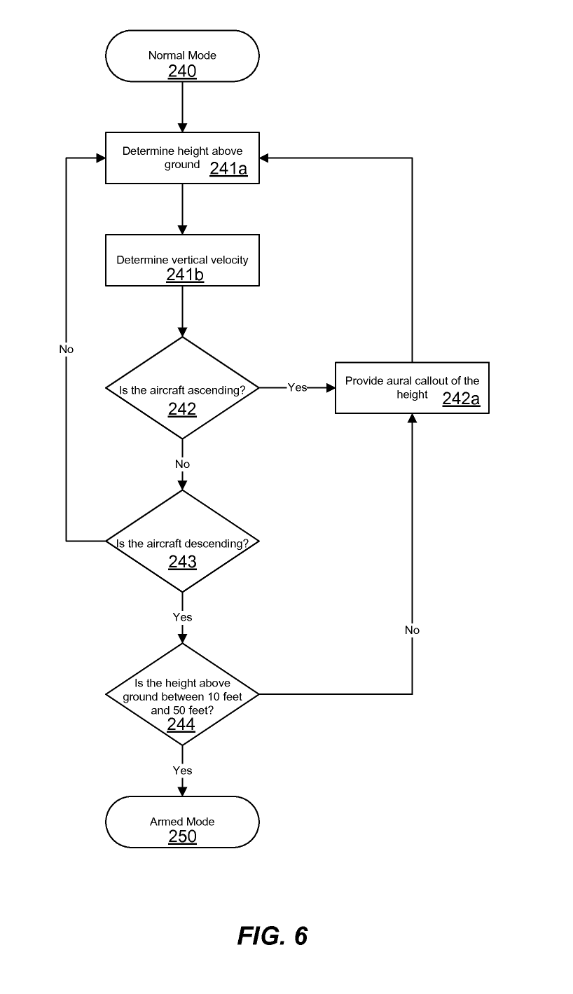

In the normal operating mode 240, illustrated in FIG. 6, the height above ground can be determined 241a and the vertical velocity can be determined 241b. As shown, these can be determined continually or multiple times depending upon the result of the measurements. If the aircraft is ascending 242, the height above ground can be determined multiple times or continually determined, and an aural callout of the height can be provided 242a. If the aircraft is descending 243 and the height above ground is between 10 feet and 50 feet 244, then the armed operating mode 250 can be entered. In one aspect, an aural notification that the armed operating mode 250 has been entered can be provided. If the aircraft is descending 243 and the height above ground is not between 10 feet and 50 feet 244, then an aural callout of the height can be provided 242a. In one aspect, when in the normal mode 240, aural callouts can be provided when the aircraft crosses multiples of one foot below ten feet, multiples of ten feet between ten and one hundred feet, multiples of one hundred feet between one hundred and one thousand feet, and multiples of one thousand feet above one thousand feet. These callouts can have hysteresis such that the same height above ground callout is not repeated without some other callout made in-between. For example, once a callout of 500 feet has been made, the next callout will be for 600 feet or higher or 400 feet or lower, even if 500 feet is crossed multiple times. Also, intermediate callouts can be skipped if another callout height is crossed before the previous height above ground callout has completed.

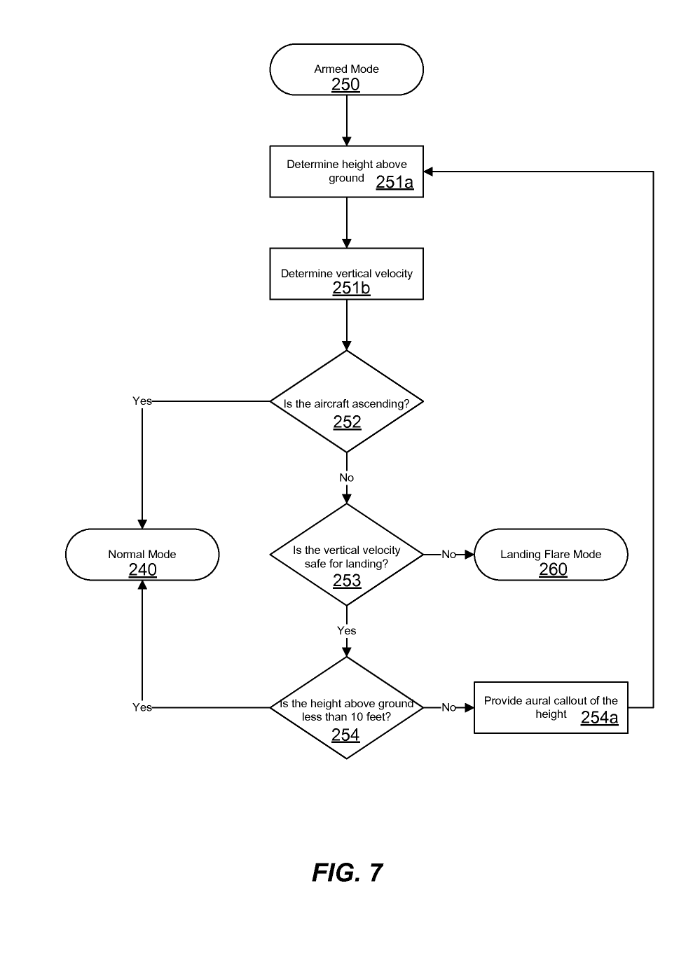

In the armed operating mode 250, illustrated in FIG. 7, the height above ground can be determined 251a and the vertical velocity can be determined 251b. These determinations can be made multiple times, continuously, etc. If the aircraft is ascending 252, then the normal operating mode 240 can be entered. If the aircraft is not ascending and the vertical velocity is not safe for landing 253, then the landing flare operating mode 260 can be entered because a landing flare maneuver is needed in order to slow the rate of descent enough for a safe landing. In one aspect, an aural notification that the landing flare operating mode 260 has been entered can be provided. One way to determine whether the vertical velocity is safe for landing is to determine whether the vertical velocity is less than the minimum descent rate limit 221 at the present height above ground. If so, then the current rate of vertical deceleration is, at present, sufficient to provide a safe vertical velocity upon landing without the need for a landing flare maneuver. If the vertical velocity is safe for landing and the height above ground is less than 10 feet 254, then the normal operating mode 240 can be entered because there is no need for a landing flare maneuver to reduce vertical velocity for a safe landing. This can be the case when the aircraft is in a low angle approach. If the vertical velocity is safe for landing 253 and the height above ground is not less than 10 feet 254, then an aural callout of the height 254a can be provided. Aural callouts of the height 254a can continue until conditions change such that a landing flare is needed to safely land or until it is determined that no landing flare will be required, such as descending below 10 feet above ground at a safe vertical landing velocity, at which point the normal operating mode can be entered.

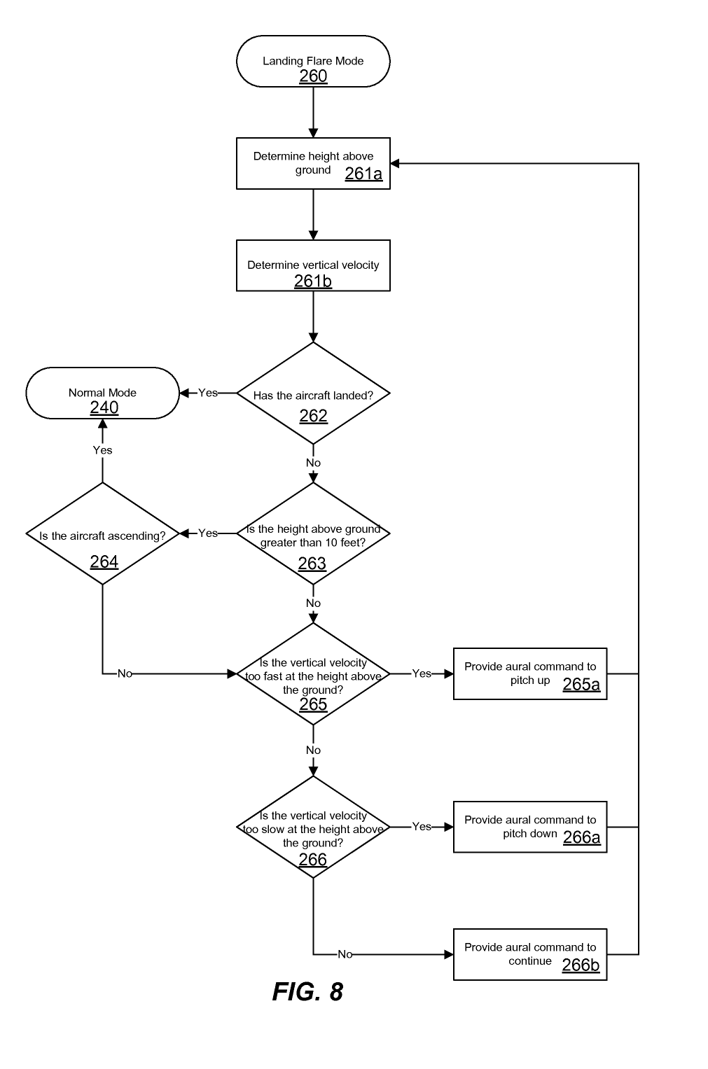

In the landing flare operating mode 260, illustrated in FIG. 8, the height above ground can be determined 261a and the vertical velocity can be determined 261b, and a flight instruction command in the form of a landing maneuver command can be determined and provided. Again, these measurements can be taken at any time, and as often as needed. If the aircraft has landed 262, then the normal operation mode 240 can be entered. One way of determining whether the aircraft has landed is to determine whether the height above ground has been below one foot for at least a predetermined minimum period of time. If the aircraft has not landed, and the aircraft is at a height greater than 10 feet above ground 263 and is ascending 264, then the normal mode 240 can be entered. Thus, if a landing has been aborted as indicated by the aircraft climbing with a height above ground in excess of 10 feet, then the normal operation mode 240 can be entered. On the other hand, if the aircraft is at a height greater than 10 feet above ground 263 and is not ascending 264, or if the aircraft is not at a height greater than 10 feet above ground 263, then a flight instruction command in the form of a landing maneuver command can be determined and provided. For example, if the vertical velocity is too fast at the height above ground 265 (i.e., the vertical velocity is greater than the maximum flare descent rate limit 222), then an aural flight instruction command in the form of a landing maneuver command can be provided, such as to facilitate changing the pitch of the aircraft upward 265a to prevent the aircraft from landing at an unsafe vertical velocity. If the vertical velocity is too slow at the height above ground 266 (i.e., the vertical velocity is less than the minimum flare descent rate limit 221), then an aural flight instruction command in the form of a landing maneuver command can be provided, such as to facilitate changing the pitch of the aircraft downward 266a. This can be helpful when the descent rate is insufficient to land the aircraft before “running out of runway.” If the vertical velocity is equal to or between the maximum and minimum landing flare descent rate limits, then an aural flight instruction command can be provided to continue 266b. In one aspect, no height above ground callouts are provided in the landing flare operating mode 260. Instead, aural flight instruction commands are provided to the pilot geared at directing and aiding the pilot in successfully completing the landing flare maneuver for a safe landing. In one aspect, the aural flight instruction commands in the landing flare operating mode 260 can be periodic (i.e. one every second) even when a command is the same as a previous command.

In one aspect, the display can show the height above ground in all operating modes where such information can be useful. For example, height above ground information can be excluded from the display in the initialization and user input operating modes if such information is not useful or needed in such operating modes or if the display is inadequate to provide height information along with the information pertinent to the particular operating mode.

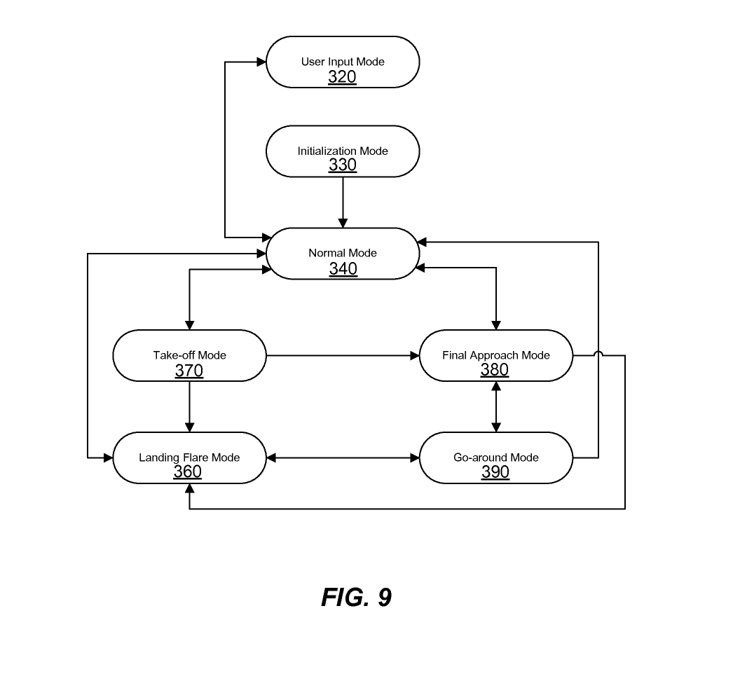

With reference to FIGS. 9-15, various modes of operation of an aircraft flying assist device or system are discussed in accordance with another example of the present disclosure. For example, as illustrated in FIG. 9, an aircraft flying assist device or system can have a user input mode 320, an initialization mode 330, a normal mode 340, a take-off mode 370, a final approach mode 380, a landing flare mode 360, and a go-around mode 390. The user input mode 320 can be similar to the user input mode 220 described hereinabove, in which the pilot can set or calibrate various device and system parameters. Minimum and maximum flare descent rate limits can be set or adjusted in the user input mode 320 as described above.

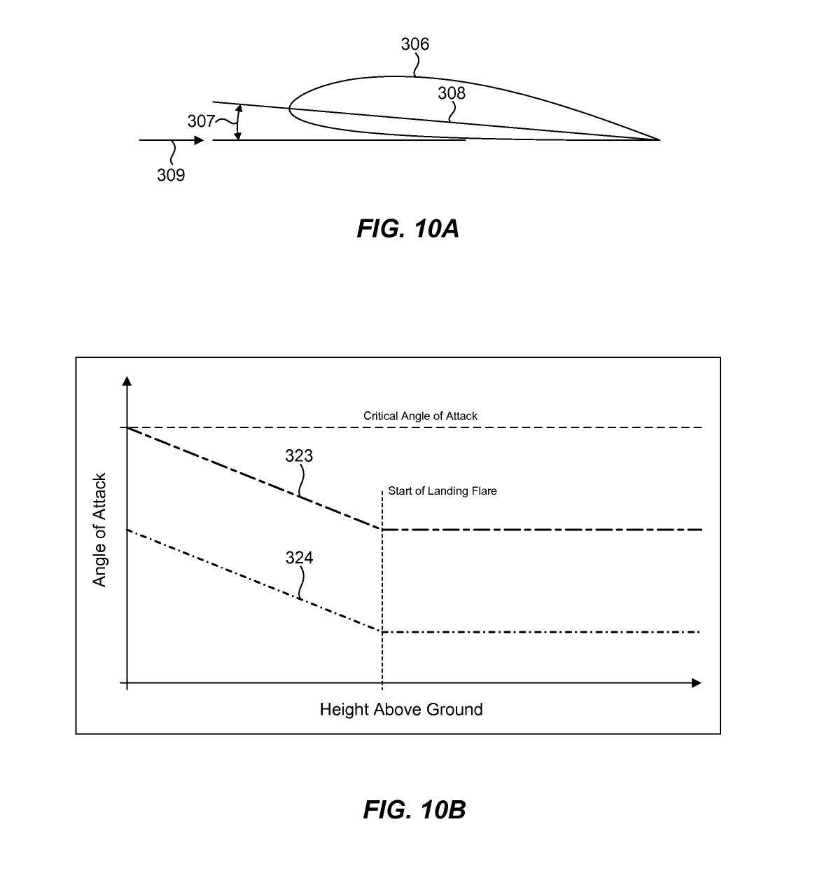

In this case, the system further includes an angle of attack sensor configured to determine an angle of attack 307 of a wing 306 of an aircraft, which is the angle of the wing 306 (i.e., a chord line 308 of the wing 306) relative to a direction 309 of oncoming airflow, as illustrated in FIG. 10A.

In one aspect, maximum and minimum angle of attack limits can be set or adjusted in the user input mode 320. Minimum and maximum angle of attack limits can vary with the height above ground or remain constant. For example, during takeoff and landing an aircraft will normally have an angle of attack that is higher than would be normal during cruise flight. Conversely during cruise flight an aircraft will have an angle of attack that is lower than optimal during takeoff or landing. As illustrated in FIG. 10B, a maximum angle of attack limit 323 and/or a minimum angle of attack limit 324 can vary with the height above ground below a height at which a landing flare is initiated and can remain constant above this height, such as at cruise altitudes. The maximum angle of attack can be set to equal a critical angle of attack at zero AGL altitude to ensure that the critical angle of attack is not exceeded during flight. The critical angle of attack is the angle of attack which produces maximum lift coefficient. Below the critical angle of attack, as the angle of attack increases, the coefficient of lift increases. Thus, it can be beneficial to approach the critical angle of attack as the airspeed decreases, such as when landing the aircraft. The minimum angle of attack limit 324 can be set to ensure that the aircraft has sufficient lift, such as when landing. In one aspect, above landing flare altitude, the maximum and minimum angle of attack limits 323, 324 can be set to for efficiency, such that sufficient lift is provided without undue drag on the wings. Thus, the angle of attack can be interpreted in the context of the current phase of flight, such as the cruise or landing phases of flight. The angle of attack can therefore be determined in any suitable operating mode and compared to a maximum and/or a minimum angle of attack limit appropriate for the phase of flight associated with the operating mode. For example, in a normal operating mode, the angle of attack can be compared to a maximum angle of attack limit appropriate for level cruise flight. An optimum angle of attack can be set during flight, which is the angle of attack when the aircraft is at the minimal controllable airspeed. In one aspect, the optimum angle of attack can be set when the aircraft is flying level at 1.3 VSO, which is the speed at which the airplane will stall in straight flight when at maximum gross weight with the power at idle, fully extended flaps, landing gear down (if so equipped), and with its center of gravity at its aft limit. In another aspect, a cruise angle of attack can be set when the aircraft is in level cruise flight.

Upon power-up, the system or device can enter the initialization mode 330, as illustrated in FIG. 9. Once a valid height above ground measurement is recognized (i.e., zero AGL altitude when on the ground), the normal operating mode 340 can be entered.

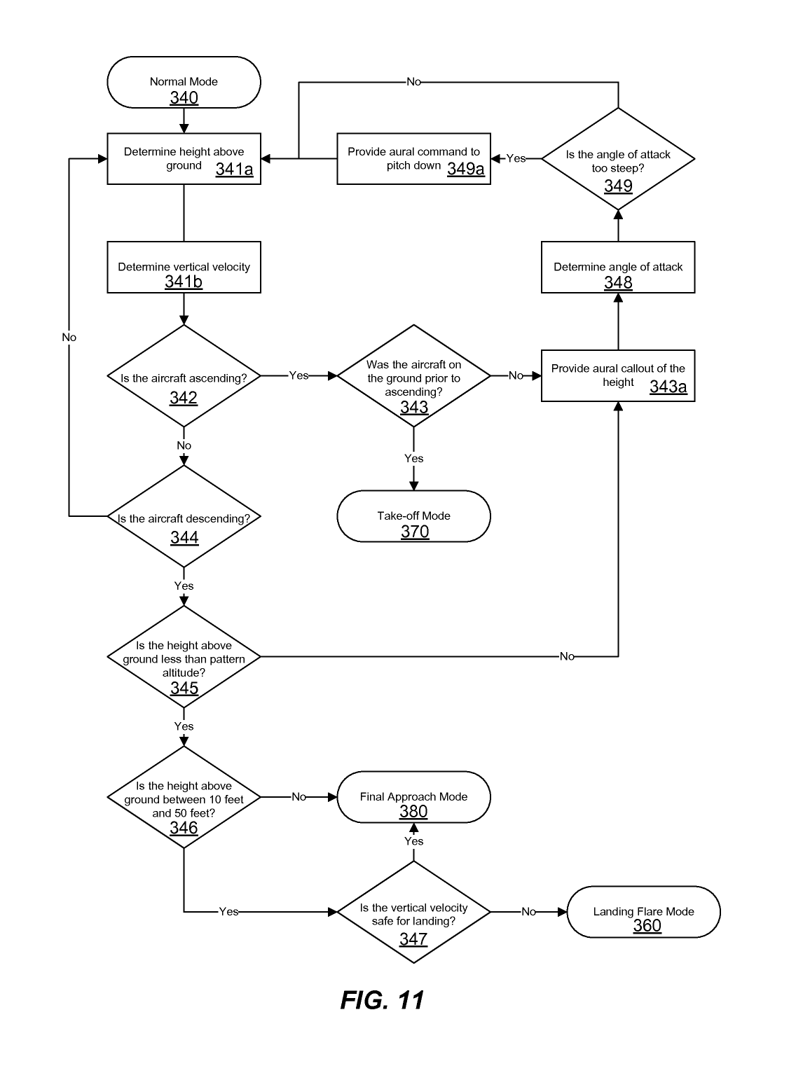

In the normal operating mode 340, illustrated in FIG. 11, the height above ground can be determined 341a and the vertical velocity can be determined 341b. These measurements can be made as often as needed, or continuously as needed. If the aircraft is ascending 342 and the aircraft was not on the ground prior to ascending 343, an aural callout of the height can be provided 343a. If the aircraft is ascending 342 and the aircraft was on the ground prior to ascending 343, then the take-off operating mode 370 can be entered. In one aspect, the system may switch to the takeoff operating mode 370 when the aircraft has a positive vertical speed (i.e. in a climb) after the height above ground has stayed at zero (within a predefined tolerance) for a predefined minimum period of time. If the aircraft is descending 344 and the height above ground is not less than pattern altitude 345, then an aural callout of the height can be provided 343a. If the height above ground is less than pattern altitude 345 and not between 10 feet and 50 feet 346, then the final approach operating mode 380 can be entered. In other words, the system can switch to the final approach mode 380 when the height above ground is below pattern altitude (typically 800 to 1,000 feet above ground level for small aircraft) and above a landing flare height with a negative vertical speed (i.e. in a descent). The final approach operating mode 380 can also be entered if the height above ground is between 10 feet and 50 feet 347 and the vertical velocity is safe for landing 347. If the vertical velocity is not safe for landing 347, then the landing flare operating mode 360 can be entered. An angle of attack of the aircraft can also be determined 348. If the angle of attack is too steep 349 (i.e., the angle of attack exceeds a maximum angle of attack limit for cruise flight), then an aural flight instruction command can be provided directing the pilot to change the pitch of the aircraft downward 349a (i.e., to reduce the pitch of the aircraft).

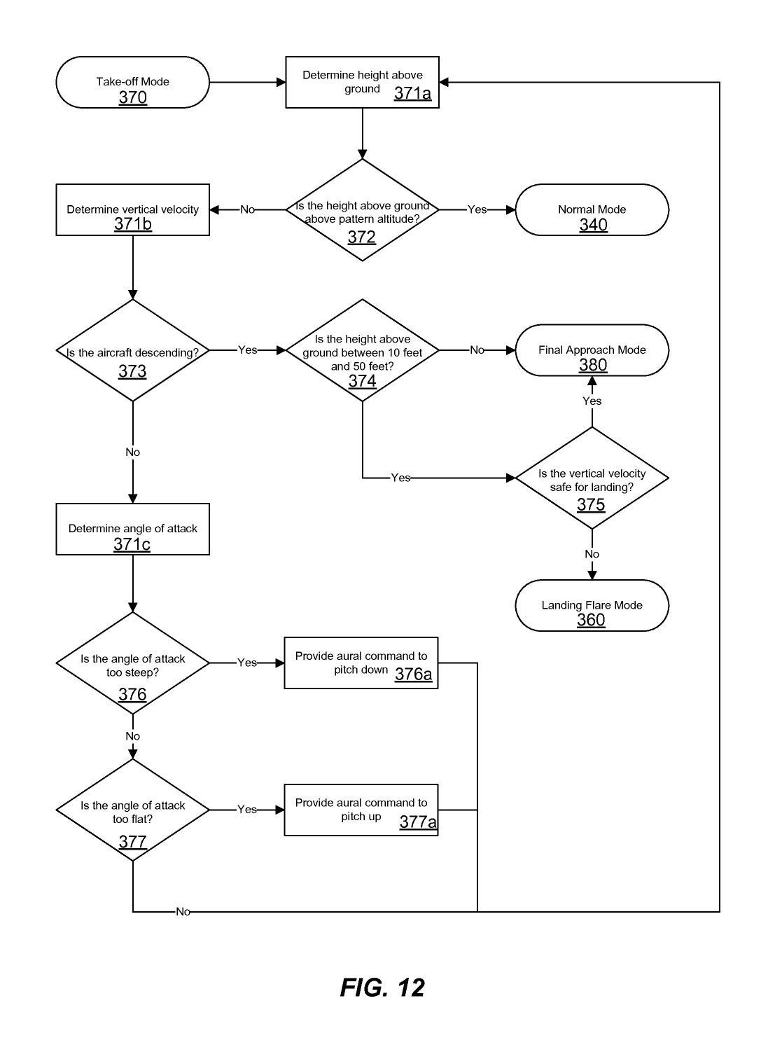

In the take-off operating mode 370, illustrated in FIG. 12, the height above ground can be determined 371a. If the height above ground is above pattern altitude 372, then the normal operating mode 340 can be entered. If the height above ground is less than pattern altitude 372, then the vertical velocity can be determined 371b. If the aircraft is descending 373 and the height above ground is not between 10 feet and 50 feet 374, then the final approach operating mode 380 can be entered because the aircraft may be, at this point, making a return to the ground. The final approach operating mode 380 can also be entered if the height above ground is between 10 feet and 50 feet 374 and the vertical velocity is safe for landing 375, which may be the case if the aircraft is returning to the ground and is so close to the ground at a safe descent rate that there is no need for a landing flare. On the other hand, if the vertical velocity is not safe for landing 375, then the landing flare operating mode 360 can be entered. Of course, if the aircraft is not descending 373, then the angle of attack can be determined 371c and monitored relative to maximum and minimum angle of attack limits to provide aural flight commands to aid the pilot in achieving a maximum performance climb. For example, if the angle of attack is too steep 376 (i.e., exceeds the maximum angle of attack limit for take-off), then an aural flight instruction command can be provided directing the pilot to change the pitch of the aircraft downward 376a. If the angle of attack is too flat 377 (i.e., is below the minimum angle of attack limit for take-off), then an aural flight instruction command can be provided directing the pilot to change the pitch of the aircraft upward 377a. In take-off mode 370, the minimum angle of attack limit can be set to achieve the best rate of climb (V_{y}) and/or the maximum angle of attack limit can be set to achieve the best angle of climb (Vₓ).

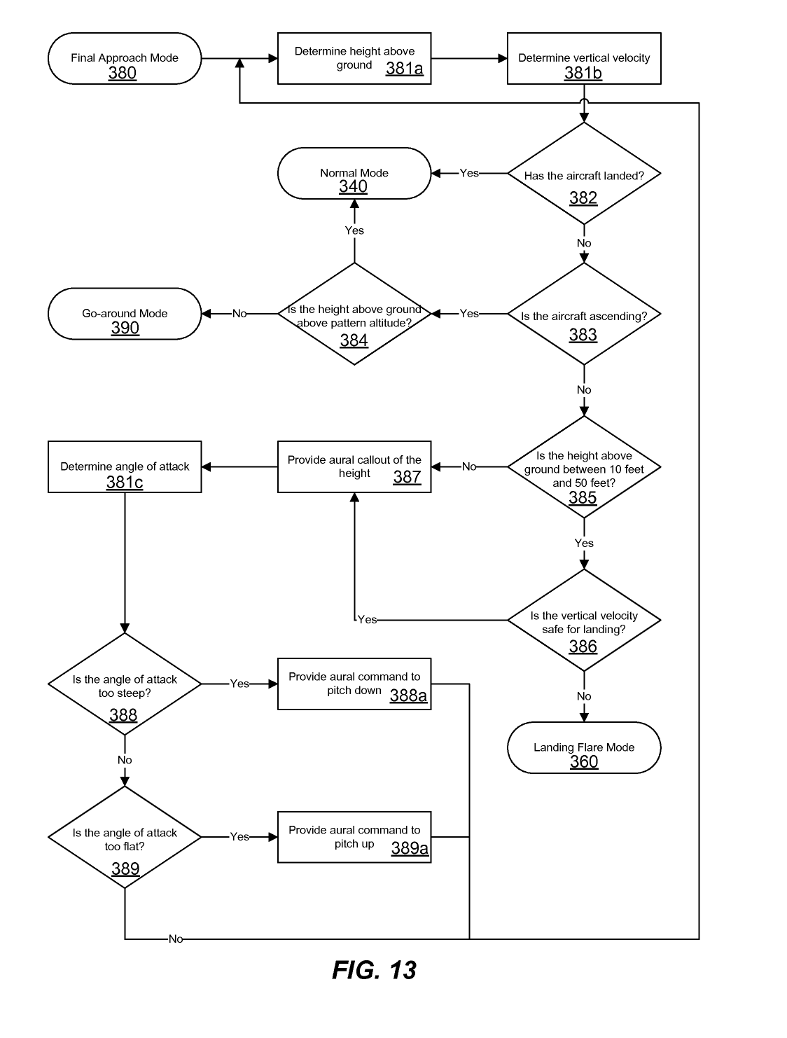

In the final approach operating mode 380, illustrated in FIG. 13, the height above ground can be determined 381a and the vertical velocity can be determined 381b. If the aircraft has landed 382 (e.g., the height above ground has been below one foot for at least a predetermined minimum period of time), then the normal operation mode 240 can be entered. On the other hand, if the aircraft is ascending 383 and the height above ground is above pattern altitude 384, then the normal operating mode 340 can be entered or, if the height above ground is not above pattern altitude 384, then the go-around operating mode 390 can be entered because, in either case, a potential landing has been aborted. In other words, the system can switch to the go-around mode 390 when in the final approach mode 380 and the aircraft has a positive vertical speed (i.e. in a climb). In one aspect, the system can switch to the go-around mode 390 only when the height above ground is above a predefined minimum go-around height. If the aircraft is not ascending 383, the height above ground is between 10 feet and 50 feet 385, and the vertical velocity is not safe for landing 386, then the landing flare operating mode 360 can be entered to provide a safe vertical landing velocity for the aircraft. If the aircraft is not ascending 383 and the height above ground is not between 10 feet and 50 feet 385, then an aural callout of the height can be provided 387. An aural callout of the height can also be provided if the aircraft is not ascending 383, the height above ground is between 10 feet and 50 feet 385, and the vertical velocity is safe for landing 386. In other words, these scenarios do not present a need to depart from the final approach operating mode 380. An aural callout of the height can be provided while in this operating mode. In the final approach mode 380, the system may also monitor the angle of attack with respect to the maximum and minimum angle of attack limits 323, 324 as represented by the limit lines to the right of the start of landing flare indication in FIG. 10B. The system may provide aural alerts when the angle of attack is above the upper angle of attack limit or below the lower angle of attack limit. Accordingly, the angle of attack can be determined 381c. If the angle of attack is too steep 388 (i.e., greater than the maximum angle of attack limit 323), then an aural flight instruction command can be provided to reduce the pitch 388a of the aircraft. If the angle of attack is too flat 389 (i.e., is less than the minimum angle of attack limit 324), then an aural flight instruction command can be provided to increase the pitch 389a of the aircraft.

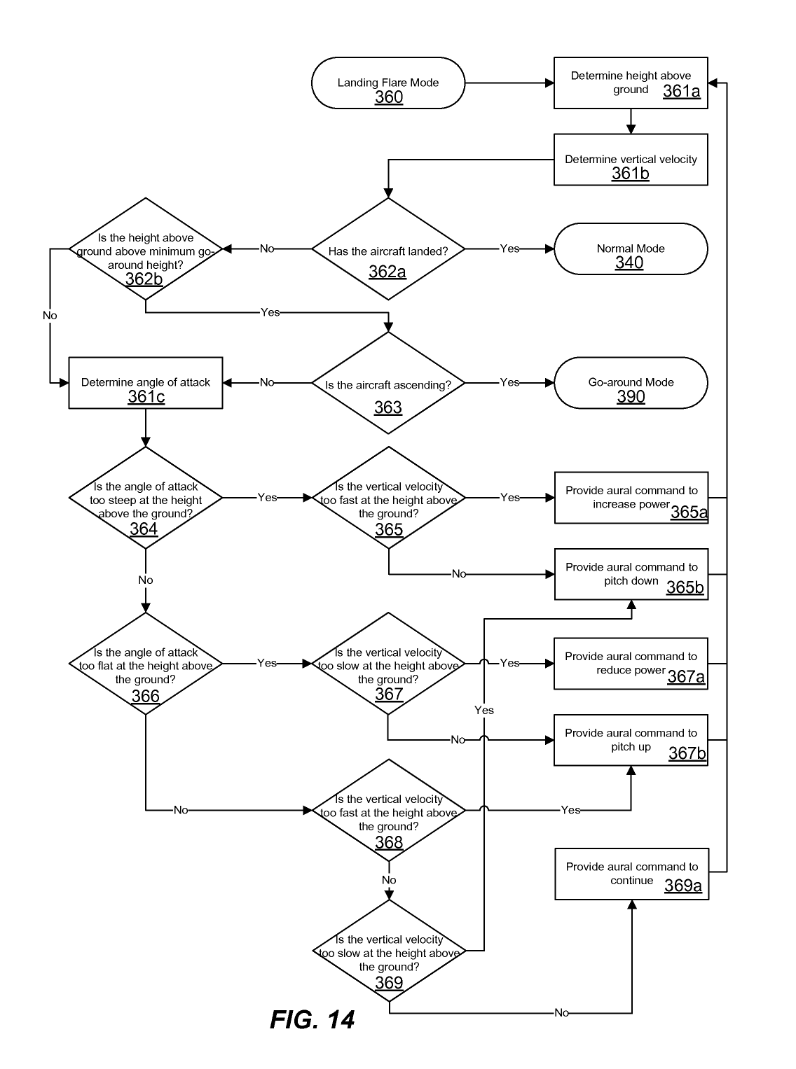

In the landing flare operating mode 360, illustrated in FIG. 14, the height above ground can be determined 361a and the vertical velocity can be determined 361b. If the aircraft has landed 362a (e.g., the height above ground has been below one foot for at least a predetermined minimum period of time), then the normal operation mode 240 can be entered. On the other hand, if the aircraft is above a predetermined minimum go-around height 362b (e.g., 10 feet) and ascending 363, then the go-around operating mode 390 can be entered because a potential landing has been aborted. In other words, the system can switch to the go-around mode 390 when in the landing flare mode 360 and the aircraft has a positive vertical speed (i.e. in a climb). In one aspect, the system can switch to the go-around mode 390 only when the height above ground is above a predefined minimum go-around height. If the aircraft is not ascending 363 or if the height above ground is below the minimum go-around height, then the angle of attack 361c can be determined. In the landing flare mode 360, the system can monitor the angle of attack with respect to maximum and minimum angle of attack limits, which may depend on the height above ground, as represented by the limit lines to the left of the start of landing flare indication in FIG. 10B. The system may provide aural flight instruction commands to aid the pilot in executing the landing flare maneuver to successfully slow the vertical velocity of the aircraft for a safe landing. If the angle of attack is too steep at the height above ground 388 (i.e., greater than the maximum angle of attack limit 323) and the vertical velocity is too fast at the height above ground 365 (i.e., the vertical velocity is greater than the maximum flare descent rate limit), then an aural flight instruction command can be provided to increase the power 365a of the aircraft. If the angle of attack is too steep at the height above ground 364 and the vertical velocity is not too fast at the height above ground 365, then an aural flight instruction command can be provided to reduce the pitch 365b of the aircraft. If the angle of attack is too flat at the height above ground 366 (i.e., is less than the minimum angle of attack limit 324) and the vertical velocity is too slow at the height above ground 367 (i.e., the vertical velocity is less than the minimum flare descent rate limit), then an aural flight instruction command can be provided to reduce the power 367a of the aircraft. If the angle of attack is too flat at the height above ground 366 and the vertical velocity is not too slow at the height above ground 367, then an aural flight instruction command can be provided to increase the pitch 367b of the aircraft. If the angle of attack is equal to or between the maximum and minimum angle of attack limits and the vertical velocity is too fast at the height above ground 368, then an aural flight instruction command can be provided to increase the pitch 367b of the aircraft. If the angle of attack is equal to or between the maximum and minimum angle of attack limits and the vertical velocity is too slow at the height above ground 369, then an aural flight instruction command can be provided to reduce the pitch 365b of the aircraft. If the angle of attack is equal to or between the maximum and minimum angle of attack limits and the vertical velocity is equal to or between the maximum and minimum landing flare descent rate limits, then an aural flight instruction command can be provided to continue 369a.

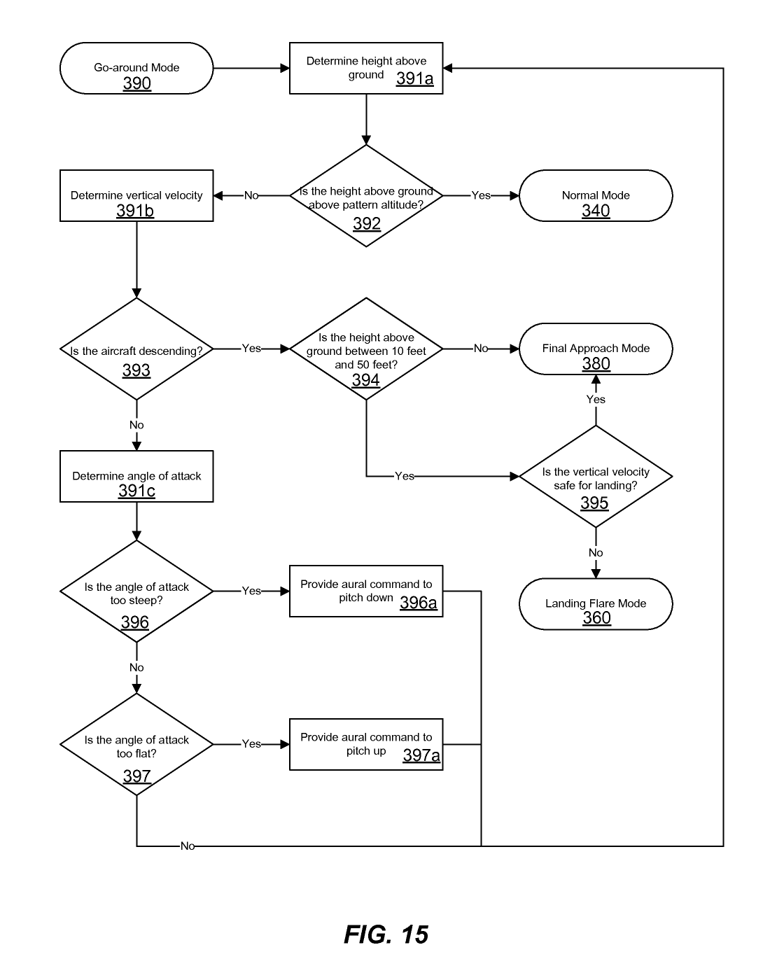

In the go-around operating mode 390, illustrated in FIG. 15, the height above ground can be determined 391a. If the height above ground is above pattern altitude 392, then the normal operating mode 340 can be entered. If the height above ground is less than pattern altitude 392, then the vertical velocity can be determined 391b. If the aircraft is descending 393 and the height above ground is not between 10 feet and 50 feet 394, then the final approach operating mode 380 can be entered because the aircraft may be, at this point, making a return to the ground. The final approach operating mode 380 can also be entered if the height above ground is between 10 feet and 50 feet 394 and the vertical velocity is safe for landing 395, which may be the case if the aircraft is returning to the ground and is so close to the ground at a safe descent rate that there is no need for a landing flare. On the other hand, if the vertical velocity is not safe for landing 395, then the landing flare operating mode 360 can be entered.

Of course, if the aircraft is not descending 393, then the angle of attack can be determined 391c and monitored relative to maximum and minimum angle of attack limits to provide aural flight commands to aid the pilot in achieving a maximum performance climb. For example, if the angle of attack is too steep 396 (i.e., exceeds the maximum angle of attack limit for take-off), then an aural flight instruction command can be provided directing the pilot to change the pitch of the aircraft downward 396a. If the angle of attack is too flat 397 (i.e., is below the minimum angle of attack limit for take-off), then an aural flight instruction command can be provided directing the pilot to change the pitch of the aircraft upward 377a. As with the take-off operating mode 370 discussed above, in the go-around operating mode 390 the minimum angle of attack limit can be set to achieve the best rate of climb (V_{y}) and/or the maximum angle of attack limit can be set to achieve the best angle of climb (Vₓ).

Although various factors or parameters have been discussed herein concerning the transitions between operating modes (e.g., based on height above ground, vertical velocity, whether ascending or descending, angle of attack, etc.), it should be recognized that any suitable factor or parameter may be used to determine a transition between operating modes, such as pilot input, the configuration of the aircraft flaps, throttle position, landing gear position, etc.

It is noted that no specific order is required in the methods disclosed herein, though generally in one embodiment, method steps can be carried out sequentially. For simplicity of explanation, methods may be depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Any of a variety of other process implementations which would occur to one of ordinary skill in the art, including but not limited to variations or modifications to the process implementations described herein, are also considered to be within the scope of this disclosure.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology. The computer readable storage medium may, for example, be in the form of a non-transitory computer readable storage medium. As used herein, the terms “medium” and “media” may be interchangeable with no intended distinction of singular or plural application unless otherwise explicitly stated. Thus, the terms “medium” and “media” may each connote singular and plural application.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof.

It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An aircraft flying assist device, comprising:
a computation module to receive data from a distance sensor to determine a height above ground between an aircraft and an underlying ground surface, and to determine a vertical velocity of the aircraft; and
a command module to determine a flight instruction command to guide a pilot of the aircraft using at least one of the height above ground and the vertical velocity.

2. The aircraft flying assist device of claim 1, wherein the flight instruction command is an aural command deliverable to the pilot via an audio output mechanism.

3. The aircraft flying assist device of claim 1, further comprising a minimum descent rate limit and a maximum descent rate limit established to assist in a landing maneuver between ground and a given height above ground.

4. The aircraft flying assist device of claim 3, wherein a slope of the minimum or maximum descent rate limits are set to the nominal AGL altitude planned for initiation of a landing flare, divided by the nominal vertical velocity of the aircraft's approach.

5. The aircraft flying assist device of claim 3, wherein a slope of the minimum or maximum descent rate limits are based on a time from initiation of a flare to touchdown.

6. The aircraft flying assist device of claim 3, further comprising a landing flare operation mode activated based on a determination of a vertical velocity and height above ground of the aircraft relative to the minimum and maximum descent rate limits, wherein the flight instruction command comprises a landing maneuver command.

7. The aircraft flying assist device of claim 6, wherein the landing maneuver command is selected from the group consisting of a reduce pitch command, an increase pitch command, and a continue command.

8. The aircraft flying assist device of claim 6, wherein the landing maneuver command is based upon a current vertical velocity relative to at least one of the minimum and maximum descent rate limits.

9. The aircraft flying assist device of claim 3, wherein the minimum and maximum descent rate limits vary with the height above ground.

10. The aircraft flying assist device of claim 1, further comprising a minimum angle of attack limit and a maximum angle of attack limit established to assist in a landing maneuver between ground and a given height above ground, wherein the computation module is configured to receive data from an angle of attack sensor to determine an angle of attack of a wing of the aircraft.

11. The aircraft flying assist device of claim 1, wherein the computation module is configured to receive data from an angle of attack sensor to determine an angle of attack of a wing of the aircraft, and wherein the command module determines the flight instruction command using the angle of attack.

12. The aircraft flying assist device of claim 11, wherein the flight instruction command is to increase power when in a landing flare operation mode and the angle of attack is greater than a maximum angle of attack, and the vertical velocity is greater than a maximum descent rate limit.

13. The aircraft flying assist device of claim 11, wherein the flight instruction command is to reduce pitch when in a landing flare operation mode and the angle of attack is greater than a maximum angle of attack, and the vertical velocity is less than or equal to a maximum descent rate limit.

14. The aircraft flying assist device of claim 11, wherein the flight instruction command is to reduce power when in a landing flare operation mode and the angle of attack is less than a minimum angle of attack, and the vertical velocity is less than a minimum descent rate limit.

15. The aircraft flying assist device of claim 11, wherein the flight instruction command is to increase pitch when in a landing flare operation mode and the angle of attack is less than a minimum angle of attack, and the vertical velocity is greater than or equal to a minimum descent rate limit.

16. The aircraft flying assist device of claim 11, wherein the flight instruction command is to increase pitch when in a landing flare operation mode and the angle of attack is greater than or equal to a minimum angle of attack and less than or equal to a maximum angle of attack, and the vertical velocity is greater than a maximum descent rate limit.

17. The aircraft flying assist device of claim 11, wherein the flight instruction command is to reduce pitch when in a landing flare operation mode and the angle of attack is greater than or equal to a minimum angle of attack and less than or equal to a maximum angle of attack, and the vertical velocity is less than a minimum descent rate limit.

18. The aircraft flying assist device of claim 11, wherein the flight instruction command is to continue when in a landing flare operation mode and the angle of attack is greater than or equal to a minimum angle of attack and less than or equal to a maximum angle of attack, and the vertical velocity is greater than or equal to a minimum descent rate limit and less than or equal to a maximum descent rate limit.

19. The aircraft flying assist device of claim 11, wherein the flight instruction command is to reduce pitch when in a normal operation mode, a final approach operation mode, a take-off operation mode, or a go-around operation mode and the angle of attack is greater than a maximum angle of attack.

20. The aircraft flying assist device of claim 11, wherein the flight instruction command is to increase pitch when in a normal operation mode, a final approach operation mode, a take-off operation mode, or a go-around operation mode and the angle of attack is less than a minimum angle of attack.

21. The aircraft flying assist device of claim 11, wherein the flight instruction command is to continue when in a final approach operation mode and the angle of attack is greater than or equal to a minimum angle of attack and less than or equal to a maximum angle of attack.

22. The aircraft flying assist device of claim 1, further comprising at least one of a timer module and a memory module operable with the at least one of the computation module and the command module to facilitate determining at least one of the height above ground, the vertical velocity, and the flight instruction command.

23. The aircraft flying assist device of claim 1, further comprising a user interface.

24. The aircraft flying assist device of claim 1, further comprising a display.

25. An aircraft flying assist system, comprising:
a distance sensor;
a computation module to receive data from the distance sensor to determine a height above ground between an aircraft and an underlying ground surface, and to determine a vertical velocity of the aircraft; and
a command module to determine a flight instruction command to guide a pilot of the aircraft using at least one of the height above ground and the vertical velocity.

26. The aircraft flying assist system of claim 25, wherein the flight instruction command is an aural command deliverable to the pilot via an audio output mechanism.

27. The aircraft flying assist system of claim 25, wherein the distance sensor is selected from the group consisting of a LIDAR, a radar, a sonar, and combinations thereof.

28. The aircraft flying assist system of claim 25, wherein the distance sensor comprises a LIDAR in the form of a laser.

29. The aircraft flying assist system of claim 25, wherein the distance sensor comprises an altimeter.

30. The aircraft flying assist system of claim 25, further comprising an angle of attack sensor, wherein the computation module receives data from the angle of attack sensor to determine an angle of attack of a wing of the aircraft, and wherein the command module determines the flight instruction command using the angle of attack.

31. The aircraft flying assist system of claim 26, wherein the audio output mechanism is selected from the group consisting of a speaker, a headphone, an electroacoustic transducer, and a combination thereof.

32. A method of aiding a pilot in flying an aircraft, comprising:
determining a height above ground between an aircraft and an underlying ground surface;
determining a vertical velocity of the aircraft;
determining a flight instruction command to guide a pilot of the aircraft using at least one of the height above ground and the vertical velocity; and
providing the flight instruction command to the pilot.

33. The method of claim 32, wherein the flight instruction command is delivered as an aural command via an audio output mechanism.

34. The method of claim 32, further comprising applying a minimum descent rate limit and a maximum descent rate limit to assist in a landing maneuver between ground and a given height above ground.

35. The method of claim 34, wherein a slope of the minimum or maximum descent rate limits are set to the nominal AGL altitude planned for initiation of a landing flare, divided by the nominal vertical velocity of the aircraft's approach.

36. The method of claim 34, wherein a slope of the minimum or maximum descent rate limits are based on a time from initiation of a flare to touchdown.

37. The method of claim 34, further comprising initiating a landing flare operation mode based on the vertical velocity and the height above ground of the aircraft relative to the minimum and maximum descent rate limits, wherein the flight instruction command comprises a landing maneuver command.

38. The method of claim 37, wherein the landing maneuver command is selected from the group consisting of a reduce pitch command, an increase pitch command, an increase power command, a decrease power command, and a continue command.

39. The method of claim 37, wherein the landing maneuver command is based upon a current vertical velocity relative to at least one of the minimum and maximum descent rate limits.

40. The method of claim 34, wherein the minimum and maximum descent rate limits vary with the height above ground.

41. The method of claim 32, further comprising applying a minimum angle of attack limit and a maximum angle of attack limit to assist in a landing maneuver between ground and a given height above ground.

42. The method of claim 32, wherein the flight instruction command is to increase pitch when in a landing flare operation mode and the vertical velocity is greater than a maximum descent rate limit.

43. The method of claim 42, wherein the maximum descent rate limit varies with the height above ground.

44. The method of claim 32, wherein the flight instruction command is to reduce pitch when in a landing flare operation mode and the vertical velocity is less than a minimum descent rate limit.

45. The method of claim 44, wherein the minimum descent rate limit varies with the height above ground.

46. The method of claim 32, wherein the flight instruction command is to continue when in a landing flare operation mode and the vertical velocity is greater than or equal to a minimum descent rate limit and less than or equal to a maximum descent rate limit.

47. The method of claim 46, wherein the minimum and maximum descent rate limits vary with the height above ground.

48. The method of claim 32, further comprising:
determining an angle of attack of a wing of the aircraft; and
determining the flight instruction command using the angle of attack.

49. The method of claim 48, wherein the flight instruction command is to increase power when in a landing flare operation mode and the angle of attack is greater than a maximum angle of attack, and the vertical velocity is greater than a maximum descent rate limit.

50. The method of claim 48, wherein the flight instruction command is to reduce pitch when in a landing flare operation mode and the angle of attack is greater than a maximum angle of attack, and the vertical velocity is less than or equal to a maximum descent rate limit.

51. The method of claim 48, wherein the flight instruction command is to reduce power when in a landing flare operation mode and the angle of attack is less than a minimum angle of attack, and the vertical velocity is less than a minimum descent rate limit.

52. The method of claim 48, wherein the flight instruction command is to increase pitch when in a landing flare operation mode and the angle of attack is less than a minimum angle of attack, and the vertical velocity is greater than or equal to a minimum descent rate limit.

53. The method of claim 48, wherein the flight instruction command is to increase pitch when in a landing flare operation mode and the angle of attack is greater than or equal to a minimum angle of attack and less than or equal to a maximum angle of attack, and the vertical velocity is greater than a maximum descent rate limit.

54. The method of claim 48, wherein the flight instruction command is to reduce pitch when in a landing flare operation mode and the angle of attack is greater than or equal to a minimum angle of attack and less than or equal to a maximum angle of attack, and the vertical velocity is less than a minimum descent rate limit.

55. The method of claim 48, wherein the flight instruction command is to continue when in a landing flare operation mode and the angle of attack is greater than or equal to a minimum angle of attack and less than or equal to a maximum angle of attack, and the vertical velocity is greater than or equal to a minimum descent rate limit and less than or equal to a maximum descent rate limit.

56. The method of claim 48, wherein the flight instruction command is to reduce pitch when in a normal operation mode, a final approach operation mode, a take-off operation mode, or a go-around operation mode and the angle of attack is greater than a maximum angle of attack.

57. The method of claim 48, wherein the flight instruction command is to increase pitch when in a normal operation mode, a final approach operation mode, a take-off operation mode, or a go-around operation mode and the angle of attack is less than a minimum angle of attack.

58. The method of claim 48, wherein the flight instruction command is to continue when in a final approach operation mode and the angle of attack is greater than or equal to a minimum angle of attack and less than or equal to a maximum angle of attack.

59. An aircraft flying assist system, comprising:
a minimum descent rate limit; and
a maximum descent rate limit, the minimum and maximum descent rate limits assisting in a landing maneuver between ground and a given height above ground,
wherein a vertical velocity at a current height above ground of the aircraft is compared to the minimum and maximum descent rate limits, and
wherein a flight instruction command is delivered to the pilot of the aircraft based upon a result of the comparison.

60. The aircraft flying assist system of claim 59, wherein a slope of the minimum or maximum descent rate limits are set to the nominal AGL altitude planned for initiation of a landing flare, divided by the nominal vertical velocity of the aircraft's approach.

61. The aircraft flying assist system of claim 59, wherein a slope of the minimum or maximum descent rate limits are based on a time from initiation of a flare to touchdown.

62. The aircraft flying assist system of claim 59, wherein the minimum and maximum descent rate limits vary with the height above ground.

63. The aircraft flying assist system of claim 59, further comprising a minimum angle of attack limit and a maximum angle of attack limit, wherein a current angle of attack at the current height above ground of the aircraft is compared to the minimum and maximum angle of attack limits, and wherein the flight instruction command is based upon the comparison to the minimum and maximum descent rate limits and the comparison to the minimum and maximum angle of attack limits.

64. The aircraft flying assist system of claim 63, wherein the flight instruction command comprises a landing maneuver command.

65. The aircraft flying assist system of claim 64, wherein the landing maneuver command is selected from the group consisting of a reduce pitch command, an increase pitch command, an increase power command, a decrease power command, and a continue command.
